(19) United States
(12) Patent Application Publication
(10) Pub. No.: US 2011/0218723 A1
(43) Pub. Date: Sep. 8, 2011

(54) METHOD FOR PRODUCING A VEHICLE DIFFERENCE MOMENT

(76) Inventors: Andreas Erban, Loechgau (DE); Markus Henzler, Stuttgart (DE)

(21) Appl. No.: 12/998,158

(22) PCT Filed: Jul. 27, 2009
(86) PCT No.: PCT/EP2009/059640

§ 371 Date: May 24, 2011

(30) Foreign Application Priority Data
Sep. 25, 2008 (DE) 10208042363.7

(51) Int. Cl. B60T 8/1755

(52) U.S. Cl. 701/70

(57) ABSTRACT

In a method for generating a difference moment that is acting on a vehicle, the actuation of a wheel brake unit sets a difference moment between two vehicle wheels, and a difference moment is generated via an additional actuator, separately from the wheel brake unit. The setting of the desired difference moment takes place primarily via the additional actuator, the wheel brake unit being used in supplementary fashion in the event that the difference moment is unable to be set via the additional actuator.

### BACKGROUND OF THE INVENTION

1. Field of the Invention

The present invention relates to a method for producing a difference moment acting on a vehicle.

2. Description of Related Art

From published German patent application document DE 10 2006 031 511 A1, a method for stabilizing a vehicle in an extreme driving situation is known, in which a vehicle controller intervenes in the vehicle operation by automatically activating at least one wheel brake. In order to perform the stabilizing procedure more rapidly, an additional drive torque is produced at least one wheel, which produces an additional yawing moment, which facilitates the stabilizing effect of the brake intervention. In addition to the stabilizing effect, the brake deceleration that is brought about by the brake intervention can also be partially or completely compensated for by the additional drive torque, depending on the situation.

The control of the wheel brakes takes place via a vehicle control system such as an ESP system (electronic stability program) or an ABS (anti-lock braking system). In the interplay of the brakes of the wheels on the one hand, and the application of a drive torque on the other, care must be taken that the basically opposing influences of the wheel brake and the drive torque do not lead to a restriction in terms of comfort. At the same time, the stabilizing effects are to complement each other in the most optimal way possible.

Furthermore, it should be taken into account that the distribution of drive torques to the vehicle wheels, as well as the braking of individual wheels is usually performed with the aid of different vehicle control systems, which must be mutually adapted or integrated in the vehicle.

### BRIEF SUMMARY OF THE INVENTION

The present invention is based on the objective of combining the function of a vehicle control device acting on a wheel brake unit in order to apply a difference moment in the most efficient way possible, with an actuator, which is developed separately from the wheel brake unit and likewise generates a difference moment for the vehicle.

The method according to the present invention is based on a vehicle control system in a vehicle, made up of a vehicle control device, which includes at least one wheel brake unit and an additional actuator, via which a difference moment acting on the vehicle is to be generated separately from the wheel brake unit. Thus, there is the option of providing a difference moment in the vehicle both via the vehicle control device and the control of the wheel brake units, as well as via the additional actuator.

The difference moment assumes two essential tasks: For one, the differential torque generates a stabilizing yawing moment at least one axle, e.g., in order to stabilize a vehicle that is over- or understeering. For another, the difference moment aids in traction by generating a blocking effect in that a differential brake torque (active braking of the spinning wheel) or a differential drive torque is applied at a driven axle in order to maintain traction on one-sided smooth surfaces (μₛₚₗᵢₜ). In this context, in the traction situation, considerably greater difference moments are generally required in the initial acceleration range than in the stabilization case of the vehicle. A difference moment at least one driven axle exerts an intended blocking effect in the event of μₛₚₗᵢₜ; the yawing moment produced in the process is tolerated under the circumstances.

According to the method of the present invention, the desired difference moment is primarily realized via the additional actuator, which functions independently of the actuation of the wheel brake unit. The wheel brake unit is used additionally only if the desired difference moment is able to be set only partially or not at all via the additional actuator.

In this way a hierarchy in the setting of the desired difference moment is specified. The difference moment is preferably provided via the additional actuator; the vehicle control device, which includes a regulating unit as well as the wheel brake units, is used only in supplementary fashion. This hierarchical structure has a number of advantages with regard to the integration of different systems and also with regard to comfort. For one, different and separately implemented vehicle control devices and actuators may be combined with each other in the manner of a modular system, or may be integrated in the vehicle. These vehicle control devices or actuators are thus able to be produced as individual modules, separately from each other, and combined in the vehicle into an overall system. The vehicle control device acting upon the wheel brake unit assumes a so-called watch dog or monitoring function, since the difference moment is generated primarily via the additional actuator and not via the wheel brake units, the wheel brake units being activated only in the event that the generation of the difference moment is not sufficiently ensured solely via the additional actuator. As a rule, this means that the difference moment is generated exclusively via the additional actuator, which contributes to greater comfort since the additional actuator usually distributes a drive torque selectively to one vehicle wheel or a plurality of vehicle wheels, so that basically no oppositely directed moments are acting on the vehicle wheels.

The integration of the different systems is also able to be accomplished in a simple manner because both systems are moment-based and common control strategies are able to be implemented on the basis of the moments. For example, one actuating variable of a system is supplied to the other system as input variable.

In principle, various types of additional actuators may be integrated to form a vehicle control system in conjunction with the vehicle control device acting on the wheel brakes. This merely requires that the additional actuator is able to generate a difference moment in the vehicle; among these are, in particular, actuators that are to be set actively and have an asymmetrical distribution of the drive torques. This includes so-called torque-vectoring systems, which include an active coupling element for the distribution of the drive torques among the driven wheels of an axle or between driven wheels of different axles. In addition, electromotor drives are to be considered as well, e.g., wheel hub motors, via which drive torques of different magnitude are able to be applied to the different vehicle wheels. Such electric motors are preferably part of a hybrid drive, which in addition to the electric motors also include an internal combustion engine. If applicable, however, the drive of the vehicle also takes place via the electric motor exclusively. Another option for setting an additional difference moment via an active actuator is rear-wheel steering, for example.

The additional actuator may be provided either with its own control unit or be integrated into the control structure of the vehicle control device acting on the wheel brakes. In the former case, i.e., with a separate control unit, the additional actuator is part of a suitable vehicle control system, which is brought together with the vehicle control device acting upon the wheel brakes. In the latter case, i.e., for an additional actuator without its own control unit, it is possible to use actuator systems having a relatively simple structure, the control for setting the desired difference moment being implemented in the additional actuator via the controller structure of the vehicle control device acting on the wheel brakes.

The mentioned structure having a modular vehicle control device and an additional actuator, in which structure the difference moment is preferably applied via the additional actuator, has the advantage that in the event of a malfunction of the additional actuator, the desired difference moment is able to be provided at least partially, but preferably in full, by the vehicle control device acting on the wheel brakes, which, due to its monitoring functions, takes place immediately in the event that the desired difference moment is not able, or not fully able, to be generated by the additional actuator. This provides additional safety with regard to a system malfunction.

According to one preferred development, the actually realized actuating variable of the additional actuator is provided as working point to the control unit that is assigned to the wheel brake unit. This procedure is particularly suitable when the additional actuator is implemented as component of an autonomous vehicle control device, which is equipped with its own control unit. The vehicle control device acting on the wheel brakes utilizes the actually realized actuating variable as working point, so that the control in the vehicle control device acting upon the wheel brakes is able to be based on a more optimal output value, with the result that the control is able to respond more rapidly or spontaneously in instances where the additional actuator is unable to provide the desired difference moment in full. However, if the additional actuator sets the difference moment in full, the working point on which the control unit of the vehicle control device acting upon the wheel brakes is based, is dimensioned such that no system deviation is produced and it is therefore also not necessary for the wheel brakes to act in supplementary fashion in order to adjust the desired difference moment.

According to one further useful development, a setpoint torque supplied by the control unit of the vehicle control device acting on the wheel brakes is supplied to the additional actuator as input variable. This development is particularly suitable for additional actuators without their own control unit, so that the control of the additional actuator is assumed by the control unit of the vehicle control device acting upon the wheel brakes. The additional actuator is thus embedded into the control structure of the vehicle control device.

The actually realized actuating variable of the additional actuator is forwarded to the vehicle control device acting upon the wheel brakes in any event, that is to say, both when the actuator is developed without its own control unit and when it is implemented to include a separate control unit. In this context it may be useful, however, to limit the actuating variable to a maximum prior to its input in the vehicle control unit; this may be a fixed quantity, but possibly also a variable quantity as a function of instantaneous state variables of the vehicle and/or the additional actuator, which depends on the temperature of the actuator, for example. This ensures that especially in a situation in which the additional actuator is embedded in the control structure of the vehicle control device that is acting upon the wheel brakes, only a maximally possible difference moment is generated in the additional actuator, marginal conditions and safety regulations being taken into account. If this is insufficient for adjusting the desired difference moment in the vehicle, then the vehicle control device acting on the wheel brakes takes effect in supplementary manner.

Additional restrictions may be provided in the vehicle control device, preferably following the control unit existing there. The setpoint torque provided by the control unit is restricted to a setpoint torque maximum, which preferably also depends on the instantaneous driving state of the vehicle, e.g., on the vehicle speed, the transverse acceleration, or the coefficient of friction between the wheels and the road pavement. This makes it possible to adapt the difference moment to the instantaneous driving state, a restriction being able to be implemented for safety-related reasons, for instance when the coefficient of friction is very low.

The vehicle control device for acting upon the wheel brake is an ESP control system (electronic stability program), in particular, via whose actuating signals the wheel brakes on vehicle wheels lying opposite one another are able to be acted upon. Basically, any other vehicle controller is conceivable as well, however, for instance a traction controller or an anti-lock braking system.

### BRIEF DESCRIPTION OF THE DRAWINGS

FIG. 1 shows in a schematized illustration, a motor vehicle equipped with a vehicle control device for acting upon wheel brakes at the vehicle wheels, and with a torque-vectoring system for the active distribution of drive torques to different vehicle wheels.

FIG. 2 shows a circuit diagram representing the overall structure of the vehicle control device for acting upon the wheel brakes, and the torque-vectoring system.

### DETAILED DESCRIPTION OF THE INVENTION

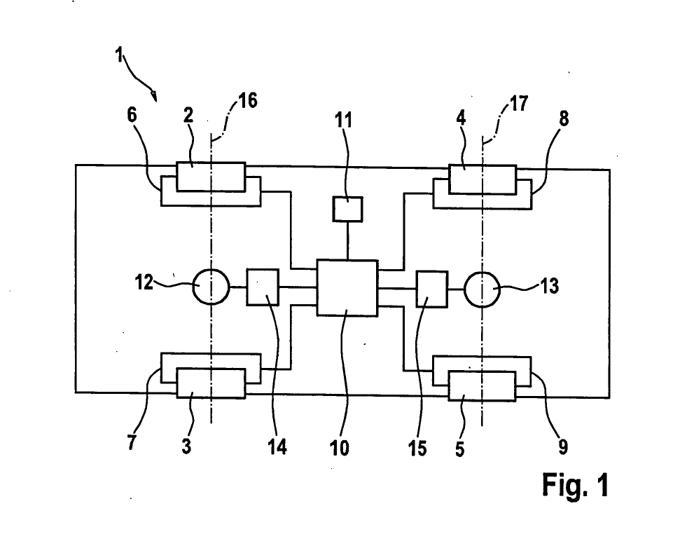

Vehicle 1 shown in FIG. 1 has front wheels 2 and 3 on a front axle 16, and rear wheels 4 and 5 on a rear axle 17, each wheel being assigned an individual wheel brake unit 6, 7, 8, 9. Wheel brake units 6 through 9 are adjusted by actuating signals of a regulation or control device 10, which is part of an ESP control system, for example. Sensor signals from a sensor system 11, which may include both an environment sensor system for detecting the vehicle environment, and a state sensor system for detecting the instantaneous vehicle state, are transmitted to regulation or control device 10. The environment sensor system, for example, includes radar sensors or optical sensors, and the state sensors are able to determine vehicle state variables of the longitudinal and/or transverse dynamics such as vehicle speed, vehicle deceleration, transverse acceleration or wheel slip values, for example.

In addition, vehicle 1 is equipped with one front and one rear torque-vectoring system 12 and 13, respectively, which is an actively adjustable coupling actuator for distributing drive torques between a left and a right driven wheel of an axle. Each torque-vectoring system 12 or 13 is assigned a control unit 14 and 15, respectively, control units 14 and 15 communicating with the central regulation or control device 10. However, torque-vectoring systems 12 and 13 acting on different axles may also be adjusted by a shared regulation unit.

In the exemplary embodiment, each axle 16, 17 of motor vehicle 1 is assigned an individual torque-vectoring system 12 or 13, that is to say, a vehicle having two driven axles is involved. However, within the framework of the present invention it is basically also sufficient to equip only one driven axle with a torque-vectoring system.

Furthermore, for the present invention it is also sufficient or possible to provide wheel hub motors in the vehicle wheels and dispense with the torque-vectoring system, the wheel hub motors of opposite vehicle wheels being controllable individually, so that different drive torques are also able to be applied to opposite-lying vehicle wheels in this manner.

A difference moment acting on the vehicle may be generated both via the vehicle control device for acting on the wheel brake, which includes regulation or control device 10 as well as wheel-brake units 6 through 9, and also via torque-vectoring system 12 or 13.

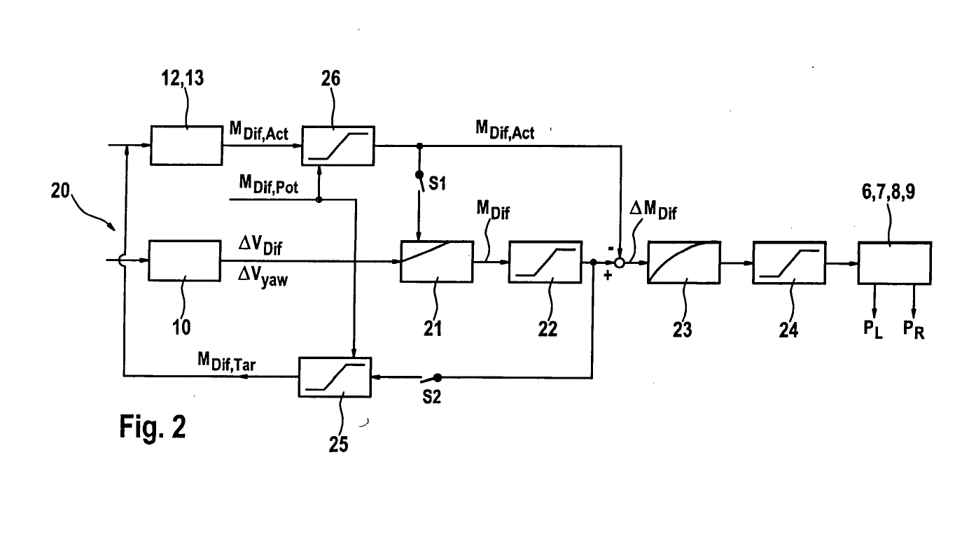

FIG. 2 shows the overall structure including vehicle control device 20 for acting upon wheel brake units 6 through 9, and torque-vectoring system 12, 13. Vehicle control device 20 includes regulation or control device 10, which, at the output, supplies as control variable a system deviation Δv_{Dif} of the wheel differential speed v_{Dif}, which indicates the speed differential between the wheels of an axle, and/or a system deviation Δv_{yaw} of yaw rate v_{yaw}. Controlled variable Δ_{Dif} or V_{yaw} is entered in control unit 21 of vehicle control unit 20, which supplies a difference moment M_{Dif} as actuating variable. Difference moment M_{Dif} constitutes a setpoint moment, which is first restricted, in a downstream limit unit 22, to a setpoint moment maximum M_{Dif,Lim}, which expediently is a function of the instantaneous state variables of the motor vehicles such as the vehicle speed, the transverse acceleration or the coefficient of friction between the wheels of the vehicle and the road.

Following limit unit 22, in a differential stage, instantaneous, actually realized difference moment M_{Dif,Act} is subtracted as actuating variable from setpoint torque M_{Dif}, possibly restricted to setpoint maximum M_{Dif,Lim}, in order to determine a system deviation ΔM_{Dif}. System deviation ΔM_{Dif} is subsequently entered in unit 23, which includes a dynamic model of torque-vectoring system 12, 13, which unit has the task of correcting a possible phase difference between the pressure control in the wheel brake units of vehicle control device 20 and in the actuator of torque-vectoring system 12, 13. Such phase differences may occur because of the more rapid response of the wheel brakes in comparison with the actuator of the torque-vectoring system. Phase differences of this type are compensated with the aid of the dynamic model in unit 23.

Following unit 23, the dynamized system deviation is entered in an additional limit unit 24, in which, analogous to limit unit 22, a limitation is implemented, preferably as a function of the instantaneous state variables of the vehicle such as the vehicle speed, for example. With the aid of limit unit 24, the especially sensitive response of the dynamic vehicle behavior to an intervention via the wheel brakes is taken into account.

Finally, the system deviation is entered in the final block of the vehicle control device, which includes wheel brake units 6 through 9, via which desired pressure p_{L} or pᵣ is adjusted in the wheel brake units at the vehicle wheels of different vehicle sides. In this way it is possible to generate a desired difference moment in the vehicle via vehicle control device 20 and action upon the wheel brake units.

In addition to vehicle control device 20, the overall system shown in FIG. 2 includes also torque-vectoring system 12, 13, via which it is likewise possible to adjust a difference moment in the vehicle via a different distribution of the drive torque to different vehicle wheels. In the interaction with vehicle control device 20, various operating modes are conceivable, as explained in the following text.

The different operating modes in the interplay of vehicle control device 20 and torque-vectoring system 12, 13 are symbolized via switches S1 and S2. Switch S1 is situated between the output of a limit unit 26, which is assigned to torque-vectoring system 12, 13, and control unit 22, which is part of vehicle control device 20. Switch S2 lies in a feedback path between the output of limit unit 22 downstream from control unit 21, and the input of torque-vectoring system 12, 13, i.e., upstream from an additional limit unit 25, which is disposed in this feedback path. Switches S1 and S2 symbolically stand for the presence (closed switch) or absence (open switch) of a corresponding connection between the mentioned units of the overall system.

In a first operating mode, switch S1 is closed and switch S2 is open. This operating mode is preferably used in the event that the additional actuator for generating a difference moment—in the exemplary embodiment, the torque-vectoring system—is provided with its own control unit, via which the desired difference moment is to be set via the torque-vectoring system. In this case, the feedback loop between the output of control unit 21 of vehicle control device 20 and the input of torque-vectoring system 12, 13 is not mandatory.

In the first operating mode, in which switch S1 is closed, actuating variable M_{Dif,Act} actually realized in torque-vectoring system 12, 13, which may be limited to an actuating variable maximum M_{Dif,Pot} in a limit unit 26 as the case may be, is supplied as input variable to control unit 21 of vehicle control device 20. Actually realized actuating variable M_{Dif,Act} is used as working point in control unit 21 for determining actuating variable moment M_{Dif}. In a control unit 21 having an I-component, e.g., a PI controller, realized actuating variable M_{Dif,Act} represents the working point of the control circuit, the I-component. Starting from this working point, a more optimal response behavior of the controller or a more rapid adjustment of the desired torque is able to be implemented.

In addition, realized actuating variable M_{Dif,Act} is forwarded to the differential stage as input variable, i.e., on the output side of limit unit 22, which follows control unit 21. As already described earlier, realized actuating variable M_{Dif,Act} is subtracted from calculated actuating variable M_{Dif} in the differential stage, so that system deviation ΔM_{Dif} is obtained.

In a second operating mode, switch S1 is open and switch S2 is closed. This operating mode is preferably used for actuators 12, 13 without their own control unit. When switch S2 is closed, a feedback path for the feedback of setpoint torque M_{Dif} as input variable for additional actuator 12, 13 is closed. Limit unit 25 for the limiting to a maximum is provided in the feedback path; the actuating variable to be supplied to additional actuator 12, 13 as setpoint input variable is denoted by M_{Dif,Tar}.

In limit units 25 and 26, which are situated in the feedback path or in the path of the additional actuator, the limitation to a maximum value M_{Dif,Pot}, which is the torque that is maximally adjustable by additional actuator 12, 13, is implemented. M_{Dif,Pot} may be a fixed quantity, but if applicable, it may also be variable, for instance as a function of the instantaneous temperature in the additional actuator.

In both cases, i.e., both when switch S1 is closed and switch S2 is open, and when switch S1 is open and switch S2 is closed, vehicle control device 20 acts as safety function in the event that the desired difference moment is unable to be adjusted via additional actuator 12, 13 in the vehicle. Only in cases like this will a system deviation ΔM_{Dif} be obtained that is not equal to 0 and that leads to action upon wheel brake units 6 through 9. In contrast, if the desired difference moment is able to be adjusted by additional actuator 12, 13 in full, then actuating variable M_{Dif} supplied in control unit 21 is identical to actually realized actuating variable M_{Dif,Act} from additional actuator 12, 13, so that system deviation ΔM_{Dif} likewise becomes zero and wheel brake units 6 through 9 are not actuated.

The supplementary function of vehicle control device 20 comes to bear also in the event of a complete failure of additional actuator 12, 13. In this case, the difference moment is adjusted completely through action upon the wheel brake units.

1-19. (canceled)

20. A method for controlling a vehicle, comprising:
providing at least one wheel brake unit and an additional actuator;
generating a difference moment between two vehicle wheels by the additional actuator separately from the wheel brake unit; and
if a desired difference moment is unable to be achieved by actuation of the additional actuator alone, supplementing the additional actuator by actuating a wheel brake unit to achieve the desired difference moment.

21. The method as recited in claim 20, wherein an actually realized difference moment of the additional actuator is inputted to a control unit assigned to the wheel brake unit, and wherein the actually realized difference moment represents the working point of the control unit.

22. The method as recited in claim 21, wherein a setpoint torque supplied by the control unit is forwarded to the additional actuator as setpoint input variable.

23. The method as recited in claim 22, wherein the setpoint input variable is limited to an input variable maximum.

24. The method as recited in claim 23, wherein the desired difference moment is achieved completely by actuating the wheel brake unit if the additional actuator malfunctions.

25. The method as recited in claim 23, wherein the actually realized difference moment of the additional actuator is limited to an actuating variable maximum.

26. The method as recited in claim 25, wherein one of the actuating variable maximum or the input variable maximum depends on at least one instantaneous state variable of at least one of the vehicle and the additional actuator.

27. The method as recited in claim 25, wherein the setpoint torque supplied by the control unit is restricted to a setpoint torque maximum.

28. The method as recited in claim 27, wherein the setpoint torque maximum is a function of at least one of the following instantaneous state variable of the vehicle: vehicle speed, transverse acceleration and coefficient of friction.

29. The method as recited in claim 22, wherein the difference between the setpoint torque supplied by the control unit and the actually realized difference moment of the additional actuator is supplied to the wheel brake unit as an actuating variable.

30. The method as recited in claim 29, wherein, prior to acting on the wheel brake unit, the difference between the setpoint torque and the actually realized difference moment is synchronized in a dynamic model of the additional actuator with an adjustment motion of the additional actuator.

31. A vehicle control system in a vehicle, comprising:
a control device including a control unit and a wheel brake unit; and
at least one additional actuator configured to generate, separately from the wheel brake unit, a difference moment between two vehicle wheels;
wherein the wheel brake unit is configured to be actuated to supplement the additional actuator if a desired difference moment is unable to be achieved by actuation of the additional actuator alone.

32. The vehicle control system as recited in claim 31, wherein the additional actuator includes an axle differential having an integrated coupling system configured to distribute a drive torque between two vehicle wheels.

33. The vehicle control system as recited in claim 32, wherein the additional actuator includes at least one electric motor for driving at least one vehicle wheel.

34. The vehicle control system as recited in claim 33, wherein at least two vehicle wheels are each equipped with an electric wheel hub motor.

35. The vehicle control system as recited in claim 33, wherein the control device is an electronic stability control device.

36. The vehicle control system as recited in claim 35, wherein the additional actuator is part of a further vehicle control device.

37. The vehicle control system as recited in claim 35, wherein the additional actuator is embedded in the control device, and wherein a setpoint torque generated by the control unit of the control device is supplied to the additional actuator as an input variable.
